(19) United States
(12) Patent Application Publication
(10) Pub. No.: US 2026/0127368 A1
(43) Pub. Date: May 7, 2026

(54) TECHNIQUES FOR ENFORCING STRUCTURED OUTPUT OF A GENERATIVE RESPONSE ENGINE

(71) Applicant: OpenAI OpCo, LLC., San Francisco, CA (US)

(72) Inventors: Christopher Colby, Piemont, CA (US); Yun Jia Guan, Belmont, CA (US); Tomer Kaftan, San Francisco, CA (US); Michal Pokrass, San Francisco, CA (US); Ted Sanders, San Francisco, CA (US); Brian Zhang, Burlingame, CA (US)

(73) Assignee: OpenAI OpCo, LLC., San Francisco, CA (US)

(21) Appl. No.: 19/042,642

(22) Filed: Jan. 31, 2025

Related U.S. Application Data
(60) Provisional application No. 63/716,446, filed on Nov. 5, 2024.

(51) Int. Cl. G06F 40/205; G06F 16/21

(52) U.S. Cl. CPC G06F 40/205; G06F 16/211

(57) ABSTRACT

The present technology is directed to a method for constraining an output of a generative response engine to be a valid output for a structured format defined in a request received by the generative response engine, the method includes receiving the request to generate content that conforms to the structured format using the generative response engine, where the request includes a schema that defines the structured format, and generating the response to the request to generate the content, where the response conforms to the structured format.

### CROSS-REFERENCE TO RELATED APPLICATIONS

This application claims the benefit of U.S. Provisional Application No. 63/716,446, filed Nov. 5, 2024, entitled “TECHNIQUES FOR ENFORCING STRUCTURED OUTPUT OF A GENERATIVE RESPONSE ENGINE,” which is expressly incorporated herein by reference in its entirety.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example system supporting a generative response engine during inference operations in accordance with some aspects of the present technology.

FIGS. 2A and 2B illustrate an example system for using a generative response engine to create a structured output in accordance with some aspects of the present technology.

FIG. 2B illustrates an aspect of the subject matter in accordance with some aspects of the present technology.

FIG. 3 illustrates an example trie in accordance with some aspects of the present technology.

FIG. 4 illustrates an example raw index trie in accordance with some aspects of the present technology.

FIGS. 5A and 5B illustrate an example of post-processing a raw index trie in accordance with some aspects of the present technology.

FIG. 6 illustrates an example of a serialized index trie in accordance with some aspects of the present technology.

FIG. 7 illustrates a method for constraining an output of a generative response engine to be a valid output for a structured format defined in a request received by the generative response engine in accordance with some aspects of the present technology.

FIG. 8 is a block diagram illustrating an example machine-learning platform for implementing various aspects of this disclosure in accordance with some aspects of the present technology.

FIG. 9A, FIG. 9B, and FIG. 9C illustrate an example transformer architecture in accordance with some aspects of the present technology.

FIG. 10 shows an example of a system for implementing some aspects of the present technology.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. However, despite their remarkable linguistic prowess, these generative response engines ultimately output text based on statistical probabilities, as opposed to explicit understanding. While the output of generative response engines is often very good, this is the result of the very good answer being probable based on the input. But outputs that are often very good are not sufficient in some circumstances.

As an example, generative response engines are used to generate and develop code (e.g., executable code). A user account can provide a prompt requesting that the generative response engine outputs a segment of code in a particular programming language or syntax. Thus, generative response engines can, in theory, be used in efficiently writing and building executable program code in a number of different programming languages. While the output can often be very good, it can be difficult to ensure a generative response engine output matches the desired structured format. For example, the coding language might require that a block of code be encapsulated by open and closed brackets. To the extent that the generative response engine provides the open and closed brackets, this is generally a probabilistic result that occurs since much of the code it has been trained on includes open and closed brackets. However, it can occasionally happen that the generative response engine neglects an open or closed bracket, especially when there are a number of nested code blocks. This is a minor example, but such errors can be problematic for users of the generative response engine.

As a general example, the generative response engine can be prompted with a request from a user account to generate output adhering to a particular schema. The generative response engine can sample a token and output a set of possible tokens that can be sampled for the next time, thereby gradually building an output string of tokens. The sampled token at any given time affects the set of tokens that could be sampled next. Thus, if the generative response engine is trying to match a schema, once the generative response engine reads a certain substring from this token, the output may be restricted to a certain subset based on the schema. The process of generating an output constrained to a particular schema can be computationally expensive, resulting in time delays in providing a response to a user account. Accordingly, the generative response engine needs to efficiently and quickly determine the exact set of possible tokens that could extend the text following the schema.

The need for a generative response engine to adhere to a particular structure when generating an output can go beyond coding examples. There can be any number of reasons a user might need outputs provided in a particular structure, but one general case might be illustrative is in the context of applications prompting the generative response engine through APIs (application programming interfaces). Just as the APIs that the generative response engine exposes to applications require data to be placed in the correct fields, so too will the applications that consume the output of the generative response engines. Currently, applications interacting with generative response engines are configured to expect to receive unstructured data. This data might come with some labels that provide minimal structure (labels such as system messages, user messages, etc.), but not enough structure to really enable the applications working with generative response engines to leverage the output of the generative response engine.

As an example, a chatbot application might have some advanced language capabilities and some tool calling capabilities (it might even be a small generative response engine of its own), but the chatbot application might not have access to as much knowledge or as many tools as the generative response engine. In this scenario, the chatbot application might ask the generative response engine of the present technology to assist with some tasks. When the generative response engine provides a reply to the chatbot, there might be a need for the generative response engine to indicate that some portions of the response are not for the immediate consumption of the end user. If the generative response engine can be relied upon to provide its answer in a structured output, the generative response engine could provide a portion of the output in a field that should be read back to the user, and could provide other portions of the output to be communicated only to the chatbot (such as information that the chatbot might be able to use in the instance that the chatbot receives follow up questions from the end user). This is just one example, but it has recently been appreciated there might be many instances where it would be beneficial to constrain the output of a generative response engine to a particular schema.

In another example non-coding user case, a user account can use the present technology to organize unstructured data into a structured schema. The user account might have a collection of unstructured data that needs to be reviewed to find data of interest and put it into a usable output format, like comma-separated values. Anyone who has done such a data cleaning task will appreciate the time savings such technology can provide.

The present technology aims to address these and other challenges associated with generating structured output from a generative response engine. For example, the present technology addresses the accuracy of the generative response engine in providing a response that adheres to a user-provided schema. The present technology can result in a response from a generative response engine that strictly conforms to a user-supplied schema, such that the generative response engine can be efficiently and consistently used to generate responses in a structured format. For example, the present technology can be used to generate executable code in response to a prompt such that the executable code (e.g., the structured output) is free of bugs or syntax errors.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

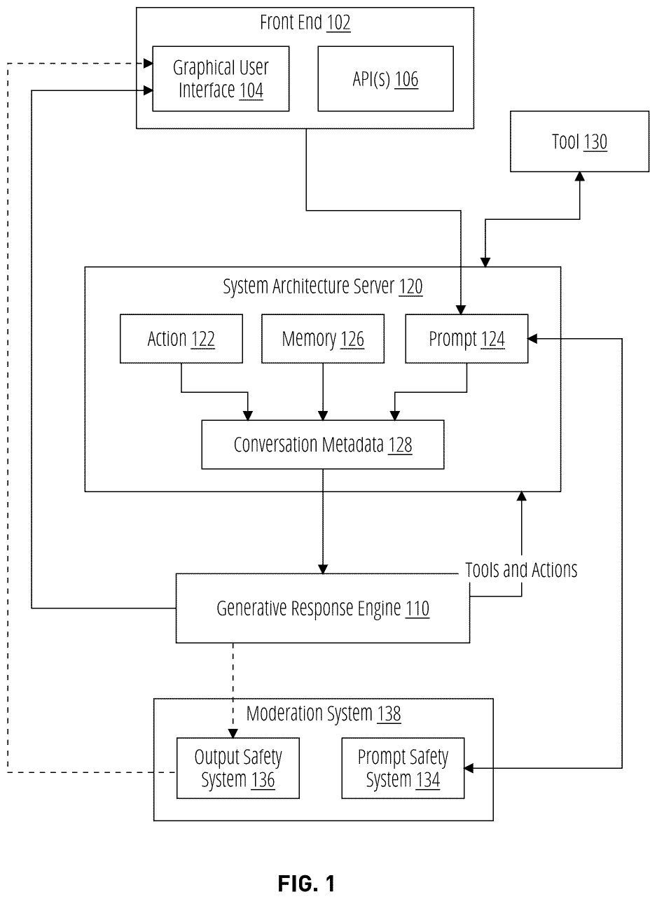

FIG. 1 illustrates an example system supporting a generative response engine during inference operations in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

Generative response engine 110 is an artificial intelligence (AI) that can generate content in response to a prompt. The prompt can be from a human or a software entity (AI or applications). The prompt is generally in natural language but could be in code, including binary. Some examples of the generative response engine can include language models that generate language, such as CHATGPT, or other models, such as DALL-E, which generates images, and SORA, which generates videos. CHATGPT, DALL-E, and SORA are all provided by OPENAI, but the generative response engine is not limited to AI provided by OPENAI. The generative response engine can also be any type of generative AI and can include AI developed using various architectures such as diffusion models and transformers (e.g., a generative pre-trained transformer) and combinations of models.

In some instances, a language model, such as CHATGPT, can receive prompts to output images, video, code, applications, etc., which it can provide by interfacing with one or more other models, as will be addressed further herein.

Users and applications can interact with generative response engine 110 through front end 102. Front end 102 serves as the interface and intermediary between the user and the generative response engine. It encompasses graphical user interface 104 and Application Programming Interfaces (APIs) 106 that facilitate communication, input processing, and output presentation. Generally, users interact through a graphical user interface 104 that often includes a conversational interface, and applications interact through API 106, but this is not a requirement.

Graphical user interface 104 is the platform through which users interact with generative response engine 110. It can be a web-based chat window, a mobile application, or any interface that supports data input and output. Graphical user interface 104 facilitates a conversation between the user and the generative response engine, as the user provides prompts in the graphical user interface 104 to which the generative response engine responds and presents those responses in the graphical user interface 104. In some aspects, graphical user interface 104 presents a conversational interface, which has attributes of a conversation thread between a user account and generative response engine 110.

Graphical user interface 104 is configured to perform input handling, context management, and output presentation. The type of inputs that can be received can be relative to the specifics of generative response engine 110. But even when a model doesn't directly accept certain types of inputs, front end 102 might be able to receive different types of inputs, which can be converted to inputs that are accepted by generative response engine 110. For example, a language model is generally configured to accept text, but front end 102 can accept voice and convert it to text or accept an image and create a textual representation.

Graphical user interface 104 is also configured to maintain the context of the conversation, which allows for coherent and relevant responses. For example, graphical user interface 104 is responsible for providing the conversation thread and other relevant context accessible to front end 102 to the generative response engine along with the specific prompt to the generative response engine. In an example, a conversation between the user account and generative response engine 110 can have taken several turns (prompt, response, prompt, response, etc.). When the user account provides a further prompt, graphical user interface 104 can provide that prompt to the generative response engine in the context of the entire conversation.

In another example, front end 102 might have access to memory 126 where facts about the user account have been stored. In some aspects, these facts can have been identified as facts worth storing by the generative response engine and front end 102 has stored these facts at the direction of the generative response engine. Accordingly, these facts can be provided to generative response engine 110 along with a user-provided prompt so that the generative response engine has access to these facts when generating a response.

In another example, graphical user interface 104 might be configured to provide a system prompt along with a user-provided prompt. A system prompt is hidden from the user account and is used to set the behavior and guidelines for the generative response engine. It can be used to define the AI's persona, style, and constraints.

Graphical user interface 104 is also configured to display the responses from the generative response engine, which might include text, code snippets, images, or interactive elements.

In some aspects, generative response engine 110 can provide instructions to front end 102 that instruct graphical user interface 104 about how to display some of the output from the generative response engine. For example, the generative response engine can direct graphical user interface 104 to present code in a code-specific format, or to present interactive graphics, or static images. In other examples, the generative response engine can direct graphical user interface 104 to present an interactive document editor where graphical user interface 104 can be presented with the document editor so that the user account and the generative response engine can collaborate on the document. In some aspects, generative response engine 110 can provide instructions to the front end 102 to record facts in a personalization notepad. Accordingly, graphical user interface 104 does not always display all of the output of the generative response engine.

Front end 102 can also provide one or more application programming interfaces (API(s)) 106. APIs enable developers to integrate the generative response engine's capabilities into external applications and services. They provide programmatic access to the generative response engine, allowing for customized interactions and functionalities.

APIs 106 can accept structured requests containing prompts, context, and configuration parameters. For example, an API can be used to provide prompts and divide the prompt into system prompts and user prompts. In some aspects, APIs 106 can provide specific inputs for which generative response engine 110 is configured to respond with a specific behavior. For example, an API can be used to specify that it requires an output in a particular format or structured output. For example, in the chat completion API, the API call can specify parameters for the output, such as the max length for the desired output, and specify aspects of the tone of the language used in the response. Some common APIs are for participating in a conversation (Chat Completion API), for providing a single response (Completion API), for converting text into embeddings (Embeddings API), etc. The API can also be used to indicate specific decision boundaries that generative response engine 110 might be trained to interpret. For example, the moderation API can take advantage of the generative response engine's content moderation decision-making. In the case of the moderation API and others, the API might give access to services other than the generative response engine. For example, the moderation API might be an interface to moderation system 138, addressed below.

Some other common APIs include the Fine-Tuning API, which allows developers to customize models of the generative response engine using their own datasets; the Audio and Speech APIs, which cause the generative response engine to output speech or audio; and the Image Generation API, which causes the generative response engine to output images (which might require utilizing other models).

There can also be APIs that direct the generative response engine to interface with other applications or other generative AI engines. In such cases, the specific application or AI engine might be specified, or the generative response engine might be allowed to choose another application of AI engine to utilize in response to a prompt.

In short, graphical user interface 104 and APIs 106 can be used to provide prompts to the generative response engine. Prompts are sometimes differentiated into prompt types. For example, a system prompt can be a hidden prompt that sets the behavior and guidelines for the generative response engine. A user prompt is the explicit input provided by the user, which may include questions, commands, or information.

Sitting in between front end 102 and generative response engine 110 is a system architecture server 120. The function of system architecture server 120 is to manage and organize the flow of data among key subsystems, enabling the generative response engine 110 to generate responses that are contextually relevant, accurate, and enriched with additional information as required.

Action 122 facilitates auxiliary tasks that extend beyond basic text generation. In some aspects, action 122 can be actions that correspond to an API 106. In some aspects, action 122 can be agentic actions that the generative response engine 110 decides to take to carry out a user's intent as described in the prompt.

Prompt 124 is the request or command provided by the user account through front end 102. In some aspects, prompt 124 can be further supplemented by a system prompt and other information that might be included by graphical user interface 104 or API 106. In some aspects, prompt 124 can even be modified or enhanced by generative response engine 110 as addressed further below. Additionally, as the user account provides prompts and generative response engine 110 provides responses, a conversation thread forms. As the user account provides a new prompt, this is appended to the overall conversation and added to prompt 124. Thus, a user account might think of a first user-provided message as a first prompt and a second user-provided message as a second prompt, and so on, but prompt 124 as perceived by generative response engine 110 can include a thread of user-provided messages and responses from generative response engine 110 in a multi-turn conversation. Generally, prompt 124 will include an entire conversation thread, but in some instances, prompt 124 might need to be shortened if it exceeds a maximum accepted length (generally measured by a number of tokens).

System architecture server 120 can also route prompts and response through moderation system 138, which can be separate or part of system architecture server 120. In some aspects, prompts are provided to prompt safety system 134 before being provided to generative response engine 110. Prompt safety system 134 is configured to use one or more techniques to evaluate prompts to ensure a prompt is not requesting generative response engine 110 to generate moderated content. In some aspects, prompt safety system 134 can utilize text pattern matching, classifiers, and/or other AI techniques.

Since prompts can evolve over time through the course of a conversation, consisting of prompts and responses, prompts can be repeatedly evaluated at each turn in the conversation.

Memory 126 can facilitate continuity and personalization in conversations. It allows the system to maintain user-specific context, preferences, or details that may inform future interactions. A memory file can be persisted data from previous interactions or sessions that provide background information to maintain continuity. In some aspects, memory can be recorded at the instruction of generative response engine 110 when generative response engine 110 identifies a fact or data that it determines should be saved in memory because it might be useful in later conversations or sessions.

Conversation metadata 128 can aggregate data points relevant to the conversation, including user prompt 124, action 122, and memory 126. This consolidated information package serves as the input for generative response engine 110. Conversation metadata 128 can label parts of a prompt as user provided, generative response engine provided, a system prompt, memory 126, data from action 122 or tool 130 (addressed below).

The generative response engine is the core engine that processes inputs (from system architecture server 120) and generates outputs. In some aspects, the generative response engine is a Generative Pre-trained Transformer (GPT), but it could utilize other architectures.

A core feature of generative response engine 110 is to generate content in response to prompts. When generative response engine 110 is a GPT, it is configured to receive inputs from front end 102 that provide guidance on a desired output. The generative response engine can analyze the input and identify relevant patterns and associations in the data, and it has learned to generate a sequence of tokens that are predicted as the most likely continuation of the input. Generative response engine 110 generates responses by sampling from the probability distribution of possible tokens, guided by the patterns observed during its training. In some aspects, generative response engine 110 can generate multiple possible responses before presenting the final one. Generative response engine 110 can generate multiple responses based on the input, and these responses are variations that generative response engine 110 considers potentially relevant and coherent.

In some aspects, generative response engine 110 can evaluate generated responses based on certain criteria. These criteria can include relevance to the prompt, coherence, fluency, and sometimes adherence to specific guidelines or rules, depending on the application. Based on this evaluation, generative response engine 110 can select the most appropriate response. This selection is typically the one that scores highest on the set criteria, balancing factors like relevance, informativeness, coherence, and content moderation instructions/training.

In some aspects, an instruction provided by an API 106, a system prompt, or a decision made by generative response engine 110 can cause generative response engine 110 to interpret a prompt and re-write it or improve the prompt for a desired purpose. For example, generative response engine 110 can determine to take a prompt to make a picture and enhance the prompt to yield a better picture. In these instances, generative response engine 110 can generate its own prompts, which can be provided to a tool 130 or provided to generative response engine 110 to yield a better output response than the original prompt might have.

Generative response engine 110 can also do more than generate content in response to a prompt. In some aspects, generative response engine 110 can utilize decision boundaries to determine the appropriate course of action based on the prompt. In some examples, a decision boundary might be used to cause the generative response engine to recognize that it is being asked to provide a response in a particular format such that it will generate its response constrained by the particular format. In some examples, a decision boundary can cause the model to refuse to generate a responsive output if the decision is that the responsive output would violate a moderation policy. In some examples, the decision boundary might cause the generative response engine to recognize that it needs to interface with another AI model or application to respond to the prompt. For example, when the generative response engine is a language model, it might recognize that it is being asked to output an image, and therefore, it needs to interface with a model that can output images to provide a response to the prompt. In another example, the prompt might request a search of the Internet before responding. The generative response engine can use a decision boundary to recognize that it should conduct a search of the Internet and use the results of that search in responding to the prompt. In another example, the prompt might request that the generative response engine take an agentic action on behalf of the user by interacting with a third-party service (e.g., book a reservation for me at . . . ), and the generative response engine can utilize a decision boundary to recognize that it needs to plan steps to locate the third-party service, contact the third-party service, and interact with the third-party service to complete the task and then report back to the user that the action has been completed.

When generative response engine 110 determines that it should take an agentic action on behalf of the user or it should call a tool to aid in providing a quality response to the user account, generative response engine 110 might call a tool 130 or cause an action 122 to be performed. As indicated above, tools 130 can include internet browsers, editors such as code editors, other AI tools etc. Actions 122 are actions that generative response engine 110 can cause to be performed, perhaps using tool 130. As used herein actions 122 should be considered to cover a broad array of actions that generative response engine 110 can perform with or without tools 130. Tools 130 are considered to cover a wide variety of services and software that encompass tools such as a computer operating system such that generative response engine 110 can control the computer operating system on the user's behalf, to robotic actuators, to search browsers and specific applications.

Additionally, generative response engine 110 can also generate portions of responses that are not displayed to the user. For example, generative response engine 110 can direct the front end 102 to provide specific behaviors, such as directions for how to present the response from generative response engine 110 to the user account. In another example, generative response engine 110 can provide response portions dictated by an API, where portions of the response to the API might be for the consumption of the calling application but not for presentation to the end user.

In some aspects, the output of generative response engine 110 can be further analyzed by output safety system 136. While generative response engine 110 can perform some of its own moderation, there can be instances where it is desired to have another service review outputs for compliance with the moderation policy. The use of dashed lines in FIG. 1 differentiates a path using output safety system 136 and not using output safety system 136.

While FIG. 1 shows responses being provided back to front end 102 directly, in some aspects, the responses might be returned by way of system architecture server 120.

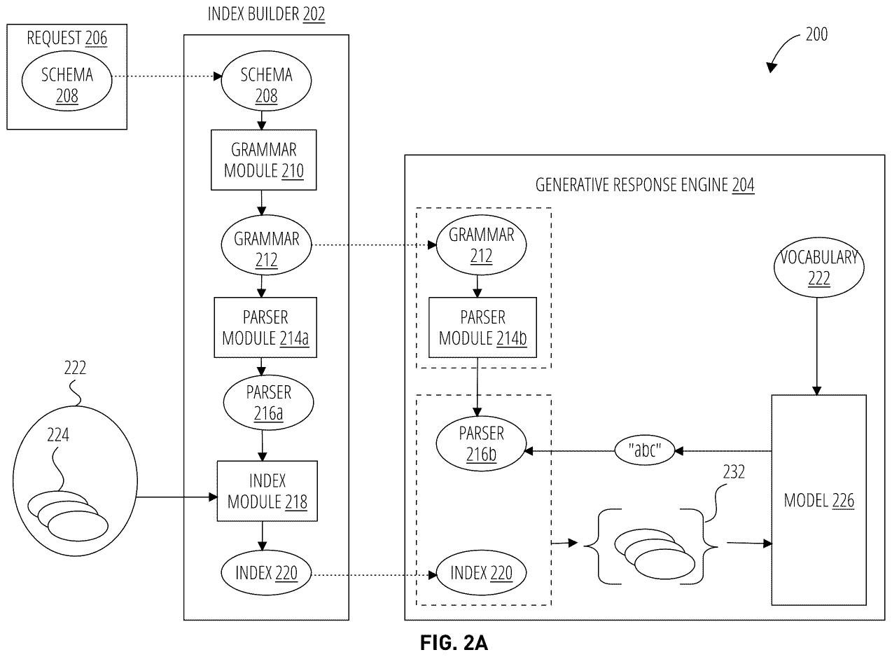

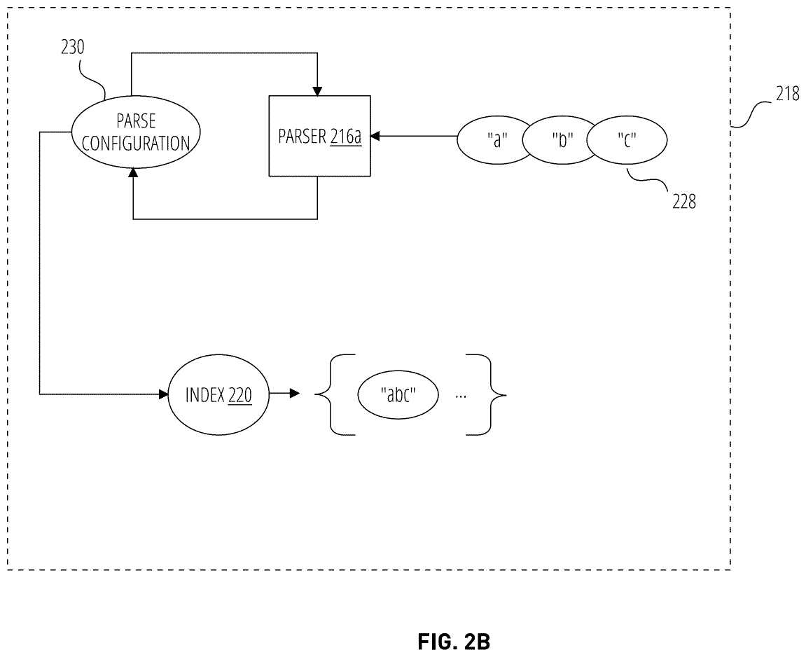

FIG. 2A illustrates an exemplary architecture of a system 200 for constraining an output of a generative response engine to be a valid output for a structured format defined in a request received by a generative response engine, in accordance with aspects of the present disclosure. The system 200 can be used, for example, to generate a response to a prompt from a user account where the user account has requested that the response be restricted to a particular schema (e.g., a JSON schema).

In some examples, the output of the generative response engine can be constrained in different ways: i) the generative response engine is constrained to output an output matching the particular schema or format exactly, and can output nothing else (e.g., no function calls); ii) the generative response engine can be constrained to output either a function call or a structured output response, as chosen by the generative response engine; or iii) the generative response engine may be constrained to output a function call and not a structured output response, even if a response format is specified. In order to implement the various constraints, special tokens can be used in the generative response engine's vocabulary (e.g., in vocabulary 222) to indicate what should be output next by the generative response engine.

System 200 can include index builder 202 and generative response engine 204. In some examples, generative response engine 204 can be the same as generative response engine 110. Index builder 202 can, for example, be hosted on a server, such as system architecture server 120, and can receive requests, or prompts, from an external source, such as a user device or an application. A request 206 or prompt for a response adhering to a particular structured format can include schema 208. For example, schema 208 can be associated with a programming language, or other structured language, and can define the structure required by that language.

Index builder 202 can include grammar module 210 for executing a process for generating grammar 212 from the received schema 208. Grammar 212 can be a context-free grammar (CFG). In some examples, grammar module 210 can apply a transformation to schema 208 to generate grammar 212. The grammar 212 can describe the syntax of schema 208 received as part of request 206. For example, if schema 208 is a JSON schema, grammar 212 can describe the syntax and rules required for an output to be an executable JSON object.

Index builder 202 can also include parser module 214a for executing a process for generating parser 216a using grammar 212 generated by grammar module 210. Parser 216a can be, for example, a data structure that can also implement a transformation. Parser 216a can be used by index module 218 of index builder 202 to generate index 220 based on grammar 212 that was generated from the received schema 208. In some examples, parser 216a can be a look-ahead, left-to-right, rightmost derivation (LALR) parser. For example, an LALR parser can be used to convert grammar 212 into an internal representation usable by generative response engine 204.

Parser 216a can be a data structure for implementing a transformation. Parser 216a can have: an initial parse configuration; a function mapping the current parse configuration and the next single character of input to the next parse configuration; and a set of final parse configurations. A parse configuration can include: a stack of parser states (which are integers); and a lexer state (which is an integer). There may be a finite number of parser states and lexer states, but because of the stack, there can be large number, maybe infinite, parse configurations.

As a non-limiting example, consider a parse configuration ([3, 9, 2, 2, 7], 4). Here, 3 is the parser state at the bottom of the stack, 7 is the parser state on the top of the stack, and 4 is the lexer state. Parser state 7 can be thought of as the part of syntax that is currently being processed. In this example the parser is expecting an integer. Lexer state 4 is a state in a finite state machine that accepts characters (e.g., digits) one at a time and can output an integer. The other parser states [3, 9, 2, 2] hold the necessary information about the context in which the parser is expecting an integer. For example, the integer may be part of an array which is the value of some property of an object.

Conceptually, the parse configuration ([3, 9, 2, 2, 7], 4) can represent nested processing where the outermost layer is on the left and the innermost layer is on the right. So input characters flow into the parser from the right and make their way through from right to left. When the next character is read in, the character goes into the lexer (state 4), which may or may not output an integer (expected by state 7), which might then consider contextual nesting deeper in the stack (the surrounding array, property, etc.).

Returning to FIG. 2A, parser 216a can be used by index module 218 of index builder 202 to generate index 220, which will be described in further detail with reference to FIG. 2B. FIG. 2B illustrates index module 218, according to some aspects of the present disclosure. Index module 218 can receive vocabulary 222 as a set of tokens 224. For example, index module 218 may receive tokens 224 of vocabulary 222 and organize the vocabulary 222 into a trie of characters 228, e.g., “a,” “b,” and “c.” Additionally, index module 218 can receive parser 216a, which is fed into abstract parser 234. Abstract parser 234 can be, for example, a module or component for processing an abstract syntax tree or trie 238. Abstract parser 234 can ingest trie 238 of characters 228. For example, abstract parser 234 may have an initial parse configuration 230. Abstract parser 234 may parse trie 238, receiving characters 228 sequentially, or receiving the entire trie 238. In some examples, abstract parser 234 can receive as input the first character “a” and the initial parse configuration 230 and can output a next parse configuration. The initial parse configuration 230 can describe an infinite set of parse configurations that will parse a respective token, built up one character at a time. The next, or current, parse configuration is being fed back into abstract parser 234 as trie 238 is read, and with a respective character 228, abstract parser 234 outputs a next parse configuration 230. The eventual output of abstract parser 234 is index 220, which defines an accepted output token or set of accepted output tokens based on a sampled input token. In other words, index module 218 can generate index 220, which can function as a dynamic dictionary from which acceptable output tokens are selected based on an input token, where the dynamic dictionary comports to schema 208. In some examples, the generated index 220 can have a tree data structure. In another example, index 220 can have a trie data structure, which can be a tree-like data structure for storing dynamic strings. In some examples, index 220 can be an index of all starting parse configurations that will parse each token 224 of vocabulary 222.

Returning to FIG. 2A, index builder 202 can create grammar 212 from schema 208 (e.g., a JSON schema), build parser 216a from grammar 212, and build index 220 from parser 216a. Index builder 202 can transmit a tuple (grammar 212, index 220, and a version number) to generative response engine 204. In some aspects, the tuple can be cached by index builder 202, so index builder 202 builds the index for the schema once. Generative response engine 204 can use grammar 212 to reconstruct parser 216a that was used to build index 220, thereby creating parser 216b. The inclusion of the version number can help ensure that there is not a mismatch between the two parsers-parser 216a that was used by index builder 202 to build index 220, and parser 216b created by generative response engine 204. Parser 216b can receive as input, tokens from model 226 at sampling time. Thus, parser 216b can iteratively generate parse configurations based on sampled tokens. In some examples, parser 216a can be passed to generative response engine 204 by index builder 202, such that generative response engine 204 uses parser 216a instead of generating parser 216b.

When generative response engine 204 is responding to a request (e.g., generating output), parser 216b may incrementally parse output from model 226. Model 226 can be, for example, a language model or a large language model (LLM). The type of output to be generated by model 226 can be specified by using special tokens that indicate to model 226 what should be output (e.g., output constrained to the schema, a function or structured output, or a function). When responding to a prompt in a constrained mode (e.g., when model 226 is to output a response adhering to a particular structure), a response by model 226 may be:
<start>assistant <format>response_format_name<separator>{ . . . }<end>
where “response_format_name” is the schema specified by the user account in the prompt and where “{ . . . }” gets pre-filled in by model 226 prior to constrained sampling by model 226. In this example, a state machine can be used to trigger constraining based on certain model outputs. Thus, once model 226 outputs the “<separator>” token, constrained sampling can be initiated.

In another example, to constrain model 226 to call a function. In one example, a user can specify that model 226 calls a specific function. For example, the prefill can be:
<start>assistant to=functions,function_name<separator>
which can constrain the model to output only valid functions per the schema. In another example, model 226 can be constrained to call a function, where the function is chosen by model 226. For example, the prefill can be:

//model prefill
<start>assistant to=functions

Model 226 will then sample the function name after, letting model 226 select which function to call. In some cases, this can present a problem as it requires constraining the model's output to a valid response per the function, but the model cannot begin constraining output immediately. To resolve this problem, a state machine can be used to trigger constraining based on certain model outputs. In this case, once the model outputs the <separator>token, it will initiate constraining.

Additionally in this example, model 226 should select a valid function name to constrain. To do this, model 226 can access a list of valid “headers” that model 226 can sample and then trigger constraining on the header depending on what is sampled. For example, given two functions: get_weather and get_pressure, the following code can be used:

//model prefill
<start>assistant to=functions.
//valid headers
get_weather<separator>
get_pressure<separator>
//schemas to constrain to for each header
get_weather_json_schema
get_pressure_json_schema

The API request can construct this “constraint machine” and supply it to generative response engine 204. Generative response engine 204 also has the ability to determine which tokens have been produced and then “flip on” constraining as needed.

In another example, model 226 can output either a function or a response per the response format if no function makes sense, per the model's decision. Given two functions as before (get_weather and get_pressure) and a response format named “output_schema”:

//model prefill
<start>assistant
//valid headers
to=functions.get_weather<separator>
to=functions.get_pressure<separator>
<format>output_schema<separator>
//schemas to constrain to for each header
get_weather_json_schema
get_pressure_json_schema
output_schema_json_schema

Model 226 can pick what it does next, and generative response engine 204 can flip on constraining when appropriate.

Returning to FIG. 2A, while implementing constrained sampling, when a token is sampled by parser 216b, parser 216b generates a new parse configuration, and that parse configuration is used in conjunction with index 220 to output a set of accepted tokens based on the sampled token. The set of accepted tokens can be determined by using the parse configuration to look up a node in index 220 containing an accepted token for the given parse configuration. The output of this process is an accepted set of tokens 232 from which model 226 can sample to generate output conforming to schema 208. The accepted set of tokens 232 can also be referred to as a dynamic dictionary. Model 226 is prevented from generating output that is not allowed by schema 208, because the universe of tokens that output can be selected from will be a set of acceptable tokens (e.g., tokens in the dynamic dictionary) as defined by index 220 given a particular parse configuration.

In another non-limiting example, a prompt (e.g., request 206) can specify that generative response engine 204 output should conform to a PL/SQL schema. Parser 216a can receive input tokens forming a SQL query (e.g., a query embedded in PL/SQL code). In this example, parser 216a can ingest a sequence of tokens “SELECT Table_1.*, Table_2.*”. In this parse configuration, a certain token set forms the set of acceptable output tokens. For example, per the schema, characters or commands following “ . . . Table_2.*” should not include “SELECT,” “SELECT ALL,” “;,” “*” (these examples should not be construed to be a complete list of unacceptable words or tokens). Index module 218 can use parser 216a to build index 220 associating the parse configuration, “SELECT Table_1.*, Table_2.*” with a set of accepted tokens given the parse configuration and any preconditions. For example, a precondition can dictate any restrictions or requirements for the output string (e.g., the output query) to be executable. Thus, a non-limiting set of acceptable tokens can include “,” (e.g., if the SELECT statement is going to select from additional tables) or “FROM.”. Thus, model 226 can parse index 220 to determine that “,” and “FROM” are tokens from which the output token can be selected.

To continue this example, supposing that a next input token to parser 216a is “FROM,” which results in a parse configuration of “SELECT Table_1.*, Table_2.* FROM”. Model 226 can traverse index 220 to retrieve a set of acceptable tokens. In this example, the set of acceptable tokens can be a single token “Table_1.” This set of acceptable tokens is now the set of tokens from which model 226 can select an output token. Accordingly, the dynamic dictionary (e.g., the set of acceptable output tokens at any given instant) changes based on an input token and a current parse configuration, thereby restricting output of model 226 to be selected from the set of acceptable tokens at a given time per the input token and parse configuration.

FIG. 2C illustrates an example of constrained sampling as described above. At inference time, e.g., when model 226 is generating output by sampling tokens from the dynamic dictionary, characters 228 are fed into parser 216b from index 220, which includes token 224 that will parse from a given starting parse configuration 240. Parser 216b may iteratively generate intermediate parse configurations 236 as characters 228 are ingested from the tokens 224 that will parse from starting parse configuration 240. Once the dynamic dictionary given a token is finished (e.g., all the starting parse configurations 240 have been run), parser 216b can output an ending parse configuration 242.

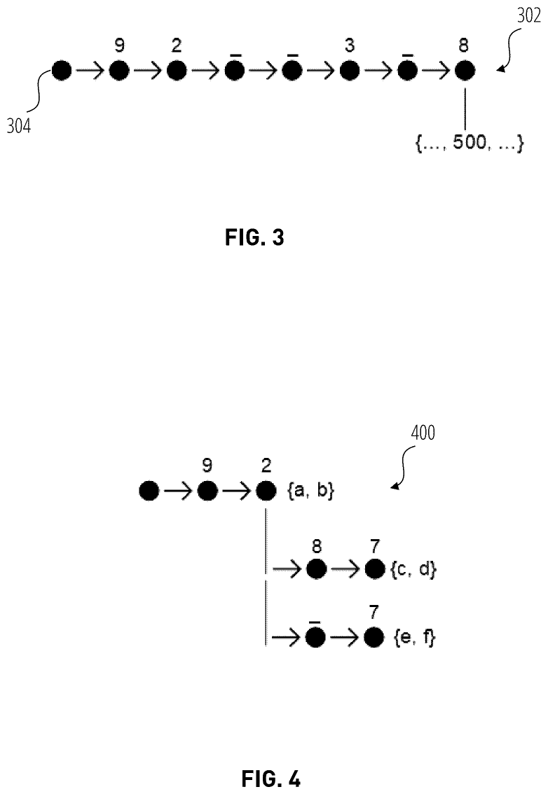

FIG. 3 provides an example of raw index generation (e.g., for generating index 220). In some examples, index 220 can be a raw index. The raw index can define a correspondence between vocabulary tokens 224 and the set of parse configurations that accept a respectivetoken. For example, the raw index can define a set of valid tokens, or characters, from which a generative response engine can select output based on an input token.

In some cases, there are some vocabulary tokens that are not accepted by any parse configuration. For example, a JSON schema without any string types might only have parse configurations that accept a small minority of tokens, since most tokens can only appear inside JSON string literals. As another example, a schema may not accept a semi-colon directly following a semi-colon (e.g., would not accept “;”). Based on an input token of “;”, the index would not include “;” in the set of tokens from which an output token can be selected by the model, thereby preventing the model from outputting “;;” which is not allowed by the schema.

The “set of parse configurations” that accept a token can, in general, be infinite, but, a finite representation of the set of parse configurations is needed. This finite representation, referred to herein as a “precondition,” can express a predicate on (i.e., set of) the parse configuration before the token in question can be consumed by the parser.

By way of non-limiting example, let ([8, _, 3, _, _, 2], 9) be a precondition. This precondition is satisfied by all parse conditions where:
9 is the lexer state.
2 is the parser state on top of the stack
3 is the parser state three below the top of the stack
8 is the parser state five below the top of the stack

In this example, “_” denotes a wildcard which matches any parser state. For example, the following parse configurations satisfy the above precondition:
([8, 1, 3, 4, 2, 2], 9)
([4, 5, 8, 6, 3, 7, 8, 2], 9)

The “stack” part of the precondition can start and end with a state, with any wildcards being somewhere in the middle of the stack. Additionally, the lexer state is an actual state, and not a wildcard.

The raw index can be represented as a trie going from the “inside out.” FIG. 3 illustrates a trie path 302 corresponding to the example precondition above (e.g., ([8, _, 3, _, _, 2], 9)). At the left is the root node 304. The rightmost node might be a leaf or could have children of its own.

The correspondence between vocabulary tokens and the set of parse configurations that accept the respective tokens is achieved by storing a respective vocabulary token (represented by its integer code) in the trie node for its corresponding precondition.

For example, let token #500 be the string “abc,” where that string is accepted by the set of parse configurations satisfying precondition ([8, _, 3, _, _, 2], 9). Then “500” would be stored in the last node in the precondition path with other tokens that satisfy the precondition as shown in FIG. 3. Thus, for the raw index, a vocabulary token can be stored in one node in the raw index trie. In this example, when the parse configuration is the precondition ([8, _, 3, _, _, 2], 9), the generative response engine can parse the raw index to reach the set of accepted output tokens for that precondition, which includes token #500.

The raw index can be a dynamic dictionary that defines correspondence of an input token to a set of allowable output tokens based on a parse configuration and any preconditions. Thus, by parsing the raw index, generative response engine 204 can retrieve the set of allowed tokens by traversing the raw index to reach a last node associated with the parse configuration and preconditions. The last node will store the set of accepted output tokens (e.g., the set of output tokens to be selected from by generative response engine 204).

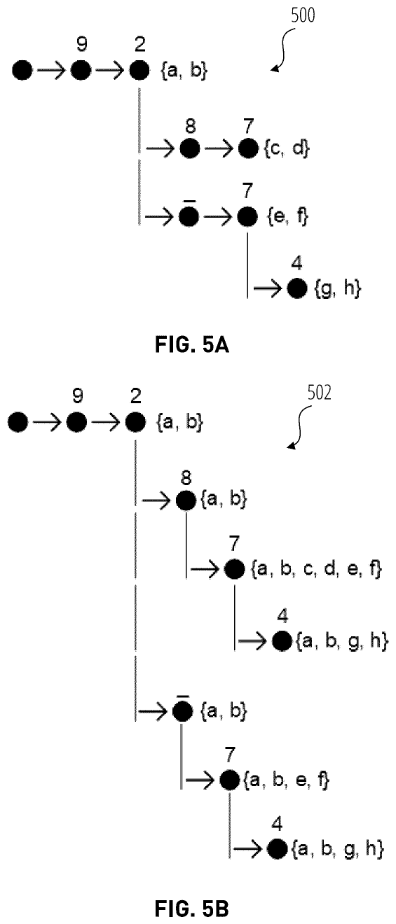

FIG. 4 illustrates an example raw index trie 400. At a respective sampling step while building the raw index, generative response engine 204 needs to answer two questions:
[index]: In the current parse configuration, what is the set of tokens T that would be accepted by the parser? This answer is computed from the index (e.g., index 220).
[parse]: In the current parse configuration, what is the next parse configuration after token t∈T is input? This answer is computed from the parser (e.g., parser 216b).

Post-processing the raw index can improve the performance of generative response engine 204 in determining the set of tokens that would be accepted by the parser. For example, answering the [index] question can involve traversing many paths in the raw index, which can be computationally expensive. A parse configuration can satisfy many preconditions resulting in traversal of many paths in the raw index trie.

As a non-limiting example, let a current parse configuration be C=([4, 5, 8, 6, 3, 7, 8, 2], 9). Parse configuration C satisfies many preconditions. Examples of preconditions satisfied by parse configuration C are:
([2], 9)
([7, 8, 2], 9)
([7, _, 2], 9)

The raw index associates a respective token with one precondition—the exact precondition for that token. In this example, let the three preconditions above correspond to six tokens {a, b, c, d, e, f} as follows:

| | | |
|---|---|---|
| ([2], 9) | ⇔ | {a, b} |
| ([7, 8, 2], 9) | ⇔ | {c, d} |
| ([7, _, 2], 9) | ⇔ | {e, f} |

This would be represented in the raw index trie 400 as shown in FIG. 4. All six of these tokens are accepted by the parse configuration C=([4, 5, 8, 6, 3, 7, 8, 2], 9).

In general, given a parse configuration C, to answer the [index] question the system may visit all raw index nodes that satisfy C and compute the union of the token sets from those nodes. A wildcard can be a potential branching point in the index trie. Accordingly, at runtime, this can negatively impact user experience by resulting in relatively long processing times from the generative response engine parsing a number of branches of the raw index trie.

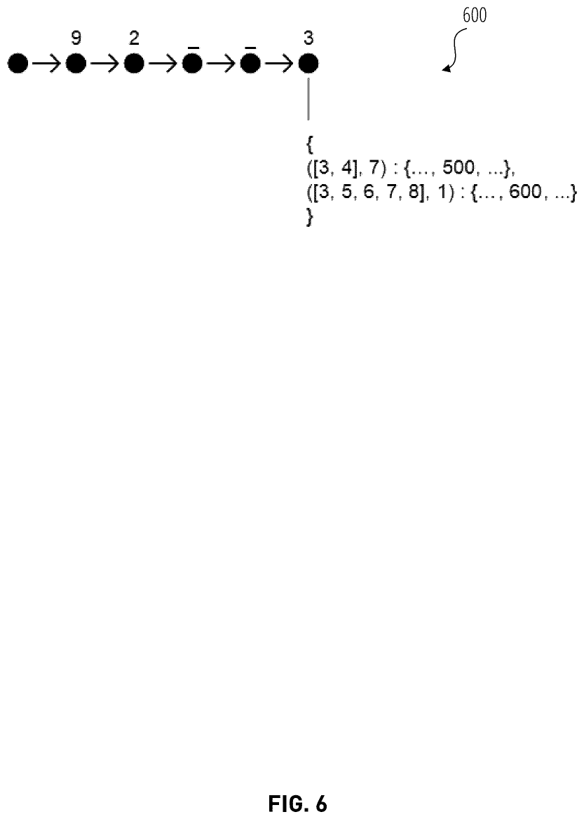

FIG. 5A illustrates an example raw index trie 500. To reduce the processing time by generative response engine 204, postprocessing the raw index builds new trie from the raw trie by precomputing this union (e.g., the union of the token sets from all of the nodes satisfying the precondition) so that generative response engine 204 can extract the answer from a single path in the trie. In other words, by post-processing raw index trie 500 (e.g., by index builder 202), generative response engine 204 can more quickly parse the dynamic dictionary (e.g., the set of acceptable tokens) to output a token that is accepted by the schema associated with the request.

FIG. 5B illustrates an example post-processed index trie 502 based on post-processing of the raw index trie 500. The post-processing of raw index trie 500 by index builder 202 can have several advantages in facilitating quick generation of the dynamic dictionary (e.g., the set of acceptable tokens for a given input token) at runtime. Given a parse configuration C, to answer the [index] question (e.g., to find the set of tokens T that would be accepted by the parser in the current parse configuration), the generative response engine identifies the index node for C by scanning C from right (the lexer parse configuration) to left (the parser parse configuration on the bottom of the stack) and correspondingly traversing the trie as follows:
If there is a matching child, take that branch.
Otherwise, if there is a wildcard, take that branch.
Otherwise, the current node has the correct set of tokens for C.

In the example illustrated by the post-processed index trie 502 in FIG. 5B:

| | |
|---|---|
| ([2], 9) | ⇒ {a, b} |
| ([1, 2], 9) | ⇒ {a, b} |
| ([4, 8, 2], 9) | ⇒ {a, b, g, h} (from path 9 → 2 → 8 → 4) |
| ([4, 1, 2], 9) | ⇒ {a, b, g, h} (from path 9 → 2 → _ → 4) |
| ([1, 7, 1, 2], 9) | ⇒ {a, b, e, f} |
| ([4, 5, 8, 6, 3, 7, 8, 2], 9) | ⇒ {a, b, c, d, e, f} |

Thus, the post-processed index trie 502 may be optimized for fast lookup by generative response engine 204. The cost of this post-processing is that there is potentially a blowup in the size of the index, since the index has both many additional branches and many copies of the token sets as the unions proliferate down the trie. This cost can be mitigated by the serialized data structure described below.

To mitigate the risk of a large increase in size of the index due to the post-processing of the index, the index can be serialized prior to being provided to generative response engine 204. In serializing the post-processed index, several considerations arise:
Size of the serialized format. If the index is too big, it canstall the inference engine and affect other traffic. For example, stalling can occur once the index reaches about 100 kb as observed during load tests.
Time spent deserializing the index by the inference engine.
Memory used by the index on the inference engine, and the impact on garbage collection if many objects are allocated.
Overhead on the inference engine to traverse the trie structure to answer the [index] question as described in the previous section.

To address these considerations, the post-processed index trie can be turned into a byte array. In some examples, the byte array can be compressed (e.g., using gzip) and encoded (e.g., b64-encoded) prior to being sent to generative response engine 204. In some examples, generative response engine 204 does not reconstruct the trie data structure, thus the deserialization cost is to decode and decompress the byte array. Further, the trie traversal addressed with reference to FIG. 5B can be done directly on the byte array. This technique can useless RAM (e.g., up to 10-100 times less RAM) compared to rehydrating the trie. Additionally, this technique allocates less memory, yielding fewer objects for garbage collection.

The byte array associated with the index trie can encode a sequence of integers where aninteger is one of three “types”:
A 4-byte address [A], which is an index into the byte array itself.
A 3-byte vocabulary token ID [V].
A 2-byte state [S], either lexer state or parser state.

The top-level byte array is the serialized_index, which includes:
[A] address of root
token_set pool
root
node pool

The token_set includes a byte sub-sequence including vocabulary token IDs ([V]) of the N tokens in the set and N*[V].

In some examples, token sets are de-duplicated such that the same token_set will not appear more than once in the pool. The form of the token_universe (e.g., sparse versus dense) can be chosen to minimize the number of bytes in the byte array. Further, the token_universe can be used so that large token sets can be represented compactly using the exclusive form.

In some examples, instead of storing the token sets in the nodes, token sets are stored in a pool. Thus, nodes having the same token sets can share the same pool containing the token set. Using this method to reduce the byte array size, a token set may not be represented more than once. Additionally, in cases in which a token set is very large (e.g., 90% or more, or 51% or more, of the vocabulary), a pool may store a negative set, instead of a positive set, further reducing the size of the byte array.

The root can include a byte sub-sequence representing the token universe (token_universe) which is the set of tokens in the index trie. The token_universe can be in one of the following forms:
undefined where [V] is zero
sparse
   1. [V] is the number of tokens the trie=N
   2. N*[V] the ids of all tokens in the trie
dense
   1. [V] is the negation of the number of tokens in the trie=N
   2. [V] is the smallest id among all tokens in the trie=A
   3. [V] is the largest id among all tokens in the trie=B
   4. (B−A−N+1)*[V] the ids of all tokens in [A+1, B−1] not in the trie path

Certain schemas may have a relatively small universe of allowed tokens from the total vocabulary available to the model. In these cases, the token universe can be represented sparsely. Conversely, a large token universe can be represented densely.

The root can also include any children of the root based on paths that originate at the root.

The node or node pool can be:
[A] address of this node's token_set where:
   0: the empty set
   A>0: (inclusive) the token_set at A
   A<0: (exclusive) the token_universe minus the token_set at −A

For children of the node:
[S] is the the number of children=N
N*child, ordered by state, with wildcard appearing last

where a child is represented as:
[S] is the child state, or 2¹⁵−1 for wildcard (_).
[A] is the address of child node

At sampling time, the generative response engine scans the serialized format of the index trie directly to answer the [index] question, (i.e., “In the current parse configuration, what is the set of tokens T that would be accepted by the parser?”). In this case, the generative response engine traverses a single path in the trie, ends at a single node, and retrieves the token set defined at that node.

At some node, the procedure to look up state S from the parse configuration is:
If node has a child with state S, return that child node.
Otherwise, if node has a wildcard child, return that child node.
Otherwise, the trie traversal for this parse configuration is complete, resulting in node.

In some examples, the children are stored as a list, not a map, which can be binary searched.

Tensor caching can be used to reduce the time complexity of the operation for retrieving a set of tokens accepted by the parser for a particular state. For example, respective nodes' token sets are turned into boolean tensors stored in a shared cache. The tensor for a token set can be keyed off the token set itself. In some cases, if the token set is very large, retrieving that token set to look up the tensor in the cache can be prohibitively expensive computationally. Therefore, as the serialized index is traversed a mapping can be built pointing from a trie node to its cached tensor. Thus, node's token set is built the first time the serialized index is traversed. Thereafter, the inference engine can jump directly from the node to its tensor.

In some examples, the raw index can further be augmented with parser functionality to answer the [index] and [parse] questions reproduced below:
[index]: In the current parse configuration, what is the set of tokens T that would be accepted by the parser? This answer is computed from the index (e.g., index 220).
[parse]: In the current parse configuration, what is the next parse configuration after token t∈T is input? This answer is computer from the parser (e.g., parser 216b).

By augmenting the index, the inference engine can answer both questions without building a separate parser. A raw index-parser can represent a correspondence between a respective vocabulary token t and the pair of: the precondition that represents the set of parse configurations that accept token t; and a description of how the parse configuration changes when t is input. Thus, the raw index-parser can be created by augmenting the raw index with a data structure describing how the parse configuration changes when t is input.

A raw index node corresponding to precondition P holds the set T of tokens accepted by the parse configurations satisfied by P. For the raw index-parser, T can be partitioned into subsets of tokens that update the parse configuration in the same way. Instead of storing T in the node, a mapping is stored from parse update Δ to the set U∈T of tokens that update the parse configuration by Δ. Here, a parse update Δ is a pair of:
The new stack of parser states that replaces the suffix of the stack that matched the precondition P. The precondition states are pushed off of the stack and the new states are pushed onto the stack.
The new lexer state.

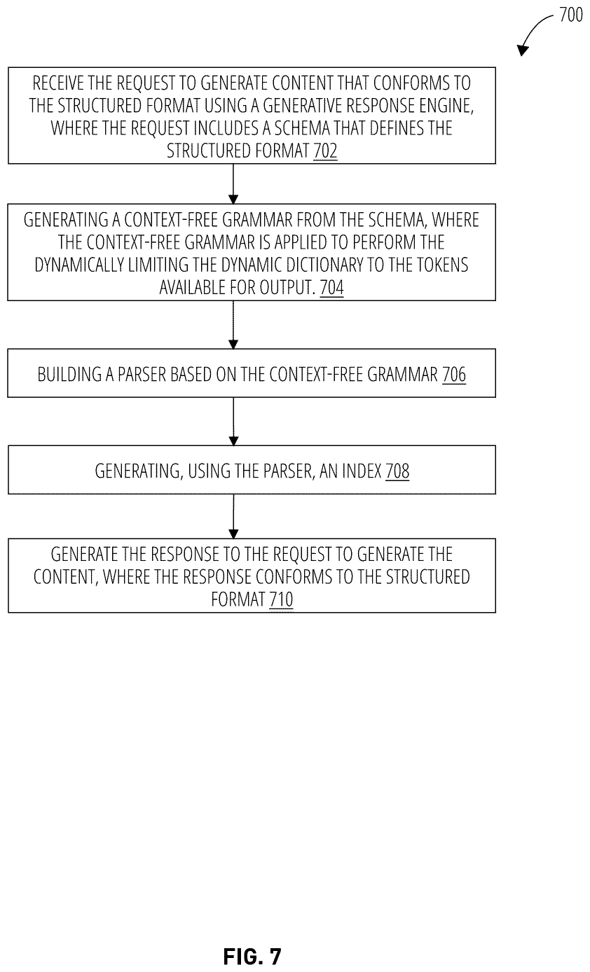

FIG. 6 illustrates an example index-parser trie 600 for the precondition node P=([3, _, _, 2], 9). This means that tokens #500 and #600 are both accepted by the parse configurations satisfying P, but these two tokens are parsed differently, resulting in different parse configurations. For example, given parse configuration ([1, 1, 1, 3, 1, 1, 2), 9):
Parsing token #500 results in parse configuration ([1, 1, 1, 3, 4], 7).
Parsing token #600 results in parse configuration ([1, 1, 1, 3, 5, 6, 7, 8), 1).

It is an invariant that the first (bottom-most) parser state in the parse update is identical to the last parser state in the precondition. In the above example, that state is 3. The state 3 is both the last edge in the trie path (i.e., the precondition)—i.e., the last parser parse statethat gets pushed off the stack—and the first parser state that gets pushed on. Therefore, the last parser state does not need to be stored it as the last parser statemay not add information. However, the last parser state in the precondition can be stored as shown in FIG. 6.

Similar to the raw index, the raw index-parser can be post-processed to improve generative response engine performance. For example, post-processing can involve copying sets of tokens in two situations. First, tokens can be copied across branches due to wild cards, from one node in a precondition (i.e., branch) to the corresponding node in a different precondition (i.e., branch) that can be matched by the same parse configuration. This copy obviates the need for the generative response engine engine to explore multiple branches of the trie at runtime. Second, tokens can be copied from ancestor to descendant nodes, which obviates the need for the generative response engine to accumulate a union as it traverses a branch in the trie.

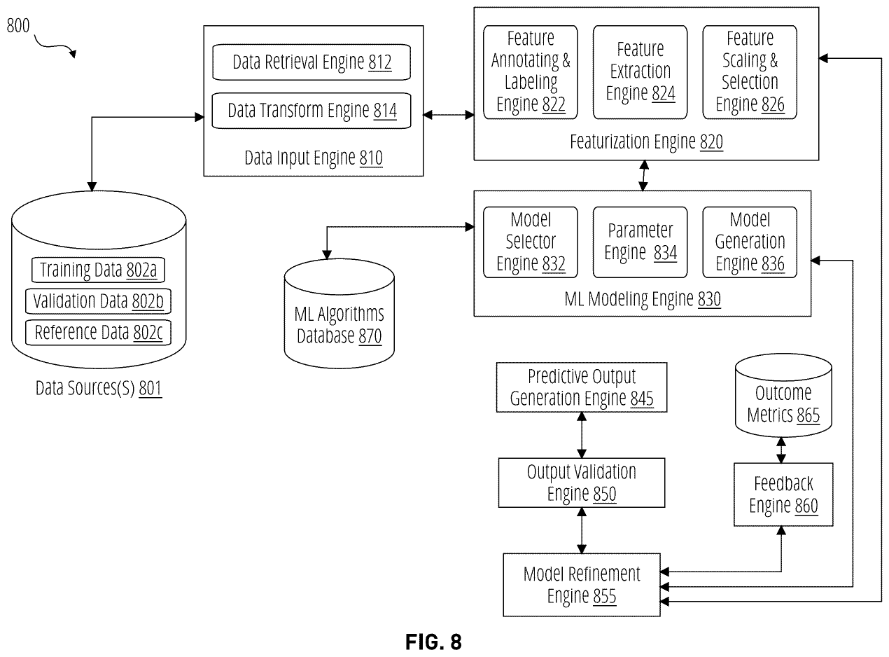

FIG. 7 illustrates an example method 700 for constraining an output of a generative response engine to be a valid output for a structured format defined in a request received by the generative response engine. Although example method 700 depicts a particular sequence of operations, the sequence may be altered without departing from the scope of the present disclosure. For example, some of the operations depicted may be performed in parallel or in a different sequence that does not materially affect the function of method 700. In other examples, different components of an example device or system that implements method 700 may perform functions at substantially the same time or in a specific sequence.

According to some examples, at block 702 method 700 can include receiving a request to generate content that conforms to a structured format using a generative response engine (e.g., generative response engine 204), where the request includes a schema that defines the structured format. The schema can be, for example, a JSON schema or other programming language or structured schema. The schema can define the format that should be output by generative response engine 204 in response to the received request. For example, the request can specify that the response from the generative response engine should conform to a JSON schema.

According to some examples, at block 704 method 700 can include generating a context-free grammar from the schema. For example, grammar module 210 of index builder 202 can apply one or more algorithms or transformations to generate grammar 212 from schema 208. The context-free grammar can, in some examples, be applied to dynamically limit a dynamic dictionary of tokens to the tokens available for output based on the schema. The context-free grammar can be, for example, a set of rules for a context-free language.

According to some examples, at block 706 method 700 can include building a parser based on the context-free grammar. For example, parser module 214a of index builder 202 can receive, as input, grammar 212 and can generate parser 216a using one or more algorithms. The parser can have an initial parse configuration, a function mapping a current parse configuration and next character of input to a next parse configuration, and a set of final parse configurations. A parse configuration can refer to a state of the parser. Any of the initial parse configuration, the current parse configuration, the next parse configuration or the set of final parse configurations can be a stack of parser states and a lexer state. In some examples, there can be a finite number of parser states and lexer states. However, because of the stack, there are an infinite number of parse configurations. As described below, a precondition can be a finite representation of the set of parse configurations that accept a token. The precondition can express a predicate on (i.e., set of) the parse configuration before the token in question can be consumed by the parser.

According to some examples, at block 708 method 700 can include generating, using the parser, an index. For example, index module 218 of index builder 202 can use parser 216a to build index 220 for schema 208, as described with reference to FIGS. 2A-2C. Generating the index can include: receiving a token of a string of tokens, where the request and the response are made up of tokens, the string of tokens including the tokens in the request and any incomplete response and determining the set of final parse configurations for the token using the function. The set of final parse configurations for the token can be based on a precondition representing a predicate on the set of final parse configurations before the token can be consumed by the parser and the precondition can include a particular lexer state and a particular stack of parser states that are satisfied by the set of final parse configurations for the token.

According to some examples, at block 710 method 700 can include generating the response to the request to generate the content, where the response conforms to the structured format. The content can be generated using the index to select valid tokens from the dynamic dictionary such that the content conforms to the structured output according to the schema. For example, generative response engine 204 can recreate parser 216a to yield parser 216b. Parser 216b can be used in conjunction with index 220 to map sampled tokens to a set of allowed tokens from which output can be selected. When generating output, model 226 is restricted to select tokens from the set of allowed tokens, thereby forcing model 226 to generate output that conforms to the requested schema.

In some examples, a user account may interact with the generative response engine on separate occasions. The user account may, at an initial time, initiate a session with the generative response engine and provide a first prompt for output conforming to a particular schema. At this time, index builder 202 may build an index (e.g., a raw index, a post-processed index, or an index-parser) based on the schema stated in the first prompt. The prompt, as well as the stated schema and index, can be stored by system architecture server 120 (e.g., in memory 126 or conversation metadata 128) as context associated with the interaction between the user account and the generative response engine.

At a subsequent time, the user account can initiate another session with the generative response engine. The user account can provide a second prompt for output conforming to the previously used schema. Based on the stored context, the generative response engine can determine that the second prompt requests output conforming to the previously specified schema and can retrieve (e.g., from memory 126 or conversation metadata 128) index 220, such that index builder 202 does not have to reconstruct index 220 each time the user account requests output conforming to a particular schema. This results in faster processing of the request by the generative response engine, thereby improving generative response engine performance and improving user experience.

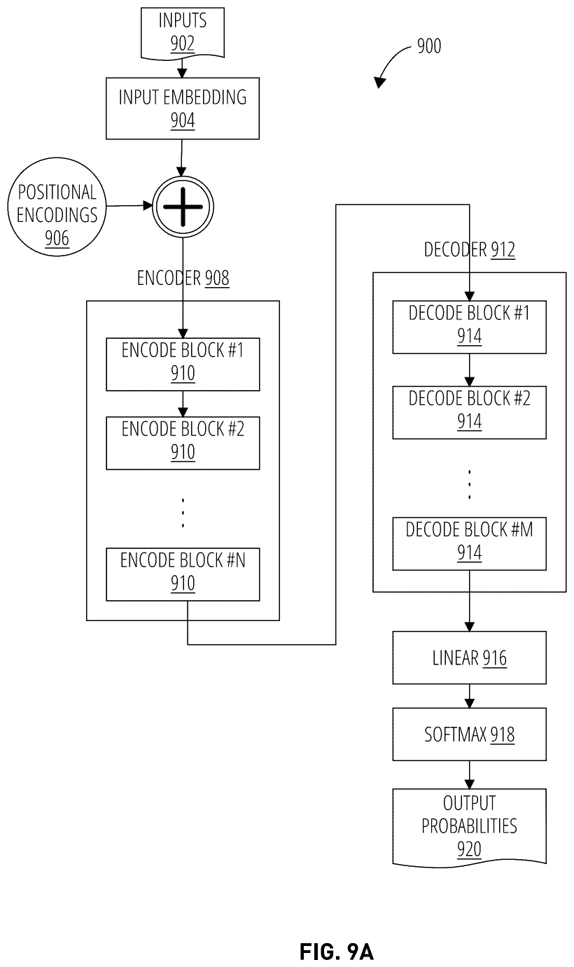

FIG. 8 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 800 may include data input engine 810 that can further include data retrieval engine 812 and data transform engine 814. Data retrieval engine 812 may be configured to access, interpret, request, or receive data, which may be adjusted, reformatted, or changed (e.g., to be interpretable by another engine, such as data input engine 810). For example, data retrieval engine 812 may request data from a remote source using an API. Data input engine 810 may be configured to access, interpret, request, format, re-format, or receive input data from data sources(s) 801. For example, data input engine 810 may be configured to use data transform engine 814 to execute a re-configuration or other change to data, such as a data dimension reduction. In some aspects, data sources(s) 801 may be associated with a single entity (e.g., organization) or with multiple entities. Data sources(s) 801 may include one or more of training data 802a (e.g., input data to feed a machine learning model as part of one or more training processes), validation data 802b (e.g., data against which at least one processor may compare model output with, such as to determine model output quality), and/or reference data 802c. In some aspects, data input engine 810 can be implemented using at least one computing device. For example, data from data sources(s) 801 can be obtained through one or more I/O devices and/or network interfaces. Further, the data may be stored (e.g., during execution of one or more operations) in a suitable storage or system memory. Data input engine 810 may also be configured to interact with a data storage, which may be implemented on a computing device that stores data in storage or system memory.

System 800 may include featurization engine 820. Featurization engine 820 may include feature annotating & labeling engine 822 (e.g., configured to annotate or label features from a model or data, which may be extracted by feature extraction engine 824), feature extraction engine 824 (e.g., configured to extract one or more features from a model or data), and/or feature scaling & selection engine 826 Feature scaling & selection engine 826 may be configured to determine, select, limit, constrain, concatenate, or define features (e.g., AI features) for use with AI models.

System 800 may also include machine learning (ML) ML modeling engine 830, which may be configured to execute one or more operations on a machine learning model (e.g., model training, model re-configuration, model validation, model testing), such as those described in the processes described herein. For example, ML modeling engine 830 may execute an operation to train a machine learning model, such as adding, removing, or modifying a model parameter. Training of a machine learning model may be supervised, semi-supervised, or unsupervised. In some aspects, training of a machine learning model may include multiple epochs, or passes of data (e.g., training data 802a) through a machine learning model process (e.g., a training process). In some aspects, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed aspects in any way, a machine learning model may include millions, billions, or even trillions of model parameters. ML modeling engine 830 may include model selector engine 832 (e.g., configured to select a model from among a plurality of models, such as based on input data), parameter engine 834 (e.g., configured to add, remove, and/or change one or more parameters of a model), and/or model generation engine 836 (e.g., configured to generate one or more machine learning models, such as according to model input data, model output data, comparison data, and/or validation data).

In some aspects, model selector engine 832 may be configured to receive input and/or transmit output to ML algorithms database 870. Similarly, featurization engine 820 can utilize storage or system memory for storing data and can utilize one or more I/O devices or network interfaces for transmitting or receiving data. ML algorithms database 870 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 870 can be considered generative response engines. Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 870 include versions DALL·E, CHAT GPT, and SORA, all provided by OPEN AI.

System 800 can further include predictive output generation engine 845 and output validation engine 850 (e.g., configured to apply validation data to machine learning model output). Predictive output generation engine 845 can analyze the input and identify relevant patterns and associations in the data it has learned to generate a sequence of words that predictive output generation engine 845 predicts is the most likely continuation of the input using one or more models from the ML algorithms database 870, aiming to provide a coherent and contextually relevant answer. Predictive output generation engine 845 generates responses by sampling from the probability distribution of possible words and sequences, guided by the patterns observed during its training. In some aspects, predictive output generation engine 845 can generate multiple possible responses before presenting the final one. Predictive output generation engine 845 can generate multiple responses based on the input, and these responses are variations that predictive output generation engine 845 considers potentially relevant and coherent. Output validation engine 850 can evaluate these generated responses based on certain criteria. These criteria can include relevance to the prompt, coherence, fluency, and sometimes adherence to specific guidelines or rules, depending on the application. Based on this evaluation, output validation engine 850 selects the most appropriate response. This selection is typically the one that scores highest on the set criteria, balancing factors like relevance, informativeness, and coherence.

System 800 can further include feedback engine 860 (e.g., configured to apply feedback from a user and/or machine to a model) and model refinement engine 855 (e.g., configured to update or re-configure a model). In some aspects, feedback engine 860 may receive input and/or transmit output (e.g., output from a trained, partially trained, or untrained model) to outcome metrics database 865. Outcome metrics database 865 may be configured to store output from one or more models and may also be configured to associate output with one or more models. In some aspects, outcome metrics database 865, or other device (e.g., model refinement engine 855 or feedback engine 860), may be configured to correlate output, detect trends in output data, and/or infer a change to input or model parameters to cause a particular model output or type of model output. In some aspects, model refinement engine 855 may receive output from predictive output generation engine 845 or output validation engine 850. In some aspects, model refinement engine 855 may transmit the received output to featurization engine 820 or ML modeling engine 830 in one or more iterative cycles.

The engines of system 800 may be packaged functional hardware units designed for use with other components or a part of a program that performs a particular function (e.g., of related functions). Any or each of these modules may be implemented using a computing device. In some aspects, the functionality of system 800 may be split across multiple computing devices to allow for distributed processing of the data, which may improve output speed and reduce computational load on individual devices. In some aspects, system 800 may use load-balancing to maintain stable resource load (e.g., processing load, memory load, or bandwidth load) across multiple computing devices and to reduce the risk of a computing device or connection becoming overloaded. In these or other aspects, the different components may communicate over one or more I/O devices and/or network interfaces.

System 800 can be related to different domains or fields of use. Descriptions of aspects related to specific domains, such as natural language processing or language modeling, is not intended to limit the disclosed aspects to those specific domains, and aspects consistent with the present disclosure can apply to any domain that utilizes predictive modeling based on available data.

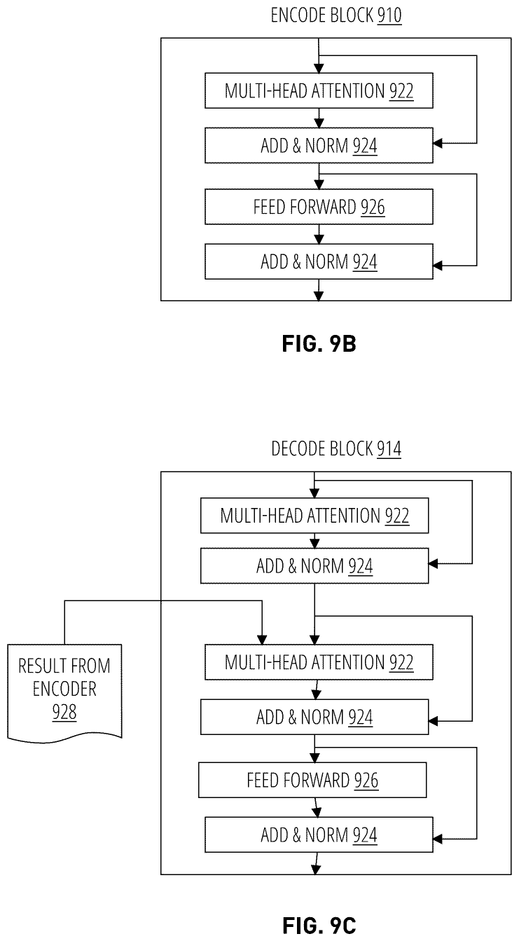

FIG. 9A, FIG. 9B, and FIG. 9C illustrates an example transformer architecture in accordance with some aspects of the present technology. Examples of ML models that use a transformer neural network (e.g., transformer architecture 900) can include, e.g., generative pretrained transformer (GPT) models and Bidirectional Encoder Representations from Transformer (BERT) models. The transformer architecture 900, which is illustrated in FIG. 9A, FIG. 9B, and FIG. 9C, includes inputs 902, input embedding block 904, positional encodings 906, encoder 908 including encode blocks 910, decoder 912 including decode blocks 914, linear block 916, softmax block 918, and output probabilities 920.

Input embedding block 904 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 904 can be learned embeddings to convert the input tokens and output tokens to vectors of dimension that have the same dimension as the positional encodings, for example.

Positional encodings 906 provide information about the relative or absolute position of the tokens in the sequence. According to certain non-limiting examples, positional encodings 906 can be provided by adding positional encodings to the input embeddings at the inputs to the encoder 908 and decoder 912. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 908 can use stacked self-attention and point-wise, fully connected layers. Encoder 908 can be a stack of N identical layers (e.g., N=6), and each layer can be an encode block, as illustrated by encode block 910 shown in FIG. 9B. Each encode block 910 has two sub-layers: (i) a first sub-layer has a multi-head attention block 922 and (ii) a second sub-layer has a feed forward block 926, which can be a position-wise fully connected feed-forward network. The feed forward block 926 can use a rectified linear unit (ReLU).

Encoder 908 uses a residual connection around each of the two sub-layers, followed by an add & norm block 924, which performs normalization. For example, the output of each sub-layer can be LayerNorm(x+Sublayer(x)). To facilitate these residual connections, all sub-layers in the model, as well as the embedding layers, produce output data having a same dimension.

Similar to encoder 908, decoder 912 uses stacked self-attention and point-wise, fully connected layers. Decoder 912 can also be a stack of M identical layers (e.g., M=6), and each layer can be a decode block, as illustrated by decode block 912 shown in FIG. 9B. In addition to the two sub-layers (i.e., the sublayer with multi-head attention block 922 and the sub-layer with feed forward block 926) found in encode block 910, decode block 914 can include a third sub-layer, which performs multi-head attention over the output of the encoder stack. Similar to encoder 908, decoder 912 uses residual connections around each of the sub-layers, followed by layer normalization. Additionally, the sub-layer with multi-head attention block 922 can be modified in the decoder stack to prevent positions from attending to subsequent positions. This masking, combined with the fact that the output embeddings are offset by one position, can ensure that the predictions for position i can depend only on the known output data at positions less than i.

Linear block 916 can be a learned linear transformation. For example, when transformer architecture 900 is being used to translate from a first language into a second language, linear block 916 can project the output from the last decode softmax block 918 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 918 then turns the scores from linear block 916 into output probabilities 920 (which add up to 1.0). In each position, the index provides for the word with the highest probability, and then maps that index to the corresponding word in the vocabulary. Those words then form the output sequence of transformer architecture 900. The softmax operation is applied to the output from linear block 916 to convert the raw numbers into output probabilities 920 (e.g., token probabilities).

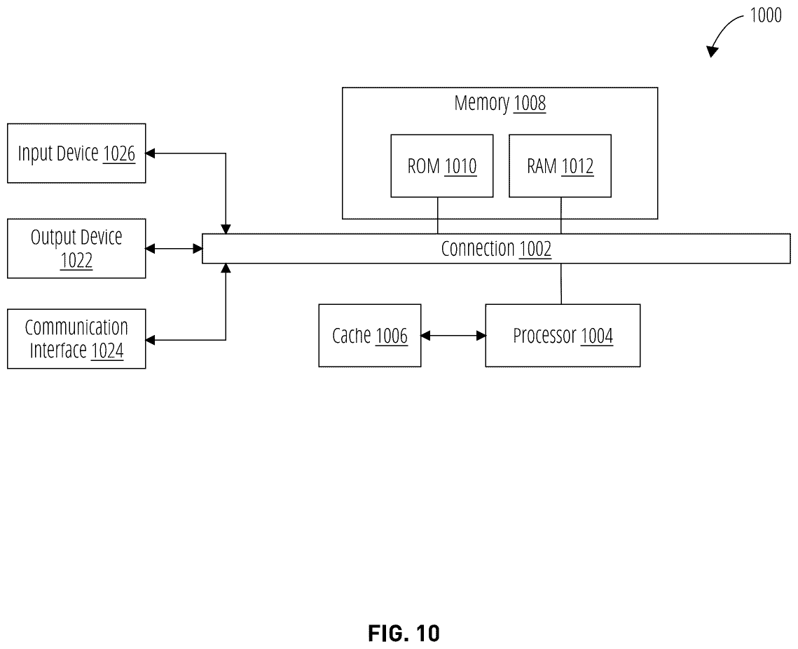

FIG. 10 shows an example of computing system 1000, which can be, for example, any computing device making up any engine illustrated in FIG. 1 or any component thereof.

In some aspects, computing system 1000 is a single device, or a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

In some aspects, computing system 1000 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 1000 includes at least one processing unit (CPU or processor) 1004 and connection 1002 that couples various system components including system memory 1008, such as read-only memory (ROM) 1010 and random access memory (RAM) 1012 to processor 1004. Memory 1008 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 1008 can include software services, servers, logic, etc., that when the code that defines such software is executed by the processor 1004, it causes the system to perform a function. In some aspects, a hardware service that performs a particular function can include the software component stored in a computer-readable medium in connection with the necessary hardware components, such as processor 1004, connection 1002, output device 1022, etc., to carry out the function.

Computing system 1000 can include a cache of high-speed memory 1006 connected directly with, in close proximity to, or integrated as part of processor 1004.

Connection 1002 can be a physical connection via a bus, or a direct connection into processor 1004, such as in a chipset architecture. Connection 1002 can also be a virtual connection, networked connection, or logical connection.

Processor 1004 can include any general purpose processor and a hardware service or software service stored in memory 1008, configured to control processor 1004 as well as a special-purpose processor where software instructions are incorporated into the actual processor design. Processor 1004 may essentially be a completely self-contained computing system, containing multiple cores or processors, a bus, memory controller, cache, etc. A multi-core processor may be symmetric or asymmetric. Processor 1004 can be physcial or virtual.

To enable user interaction, computing system 1000 includes an input device 1026, which can represent any number of input mechanisms, such as a microphone for speech, a touch-sensitive screen for gesture or graphical input, keyboard, mouse, motion input, speech, etc. Computing system 1000 can also include output device 1022, which can be one or more of a number of output mechanisms known to those of skill in the art. In some instances, multimodal systems can enable a user to provide multiple types of input/output to communicate with computing system 1000. Computing system 1000 can include communication interface 1024, which can generally govern and manage the user input and system output. There is no restriction on operating on any particular hardware arrangement, and therefore the basic features here may easily be substituted for improved hardware or firmware arrangements as they are developed.

In some aspects, computing system 1000 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some aspects, a service can be software that resides in memory of a client device and/or one or more servers of a content management system and perform one or more functions when a processor executes the software associated with the service. In some aspects, a service is a program or a collection of programs that carry out a specific function. In some aspects, a service can be considered a server. The memory can be a non-transitory computer-readable medium.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects:

The present technology includes computer-readable storage mediums for storing instructions, and systems for executing any one of the methods embodied in the instructions addressed in the Aspects of the present technology presented below:

Aspect 1. A method for constraining an output of a generative response engine to be a valid output for a structured format defined in a request received by the generative response engine, the method comprising: receiving the request to generate content that conforms to the structured format using the generative response engine, wherein the request includes a schema that defines the structured format; and generating the response to the request to generate the content, wherein the response conforms to the structured format.

Aspect 2. The method of Aspect 1, further comprising: dynamically limiting a dynamic dictionary of tokens available for selection by the generative response engine to tokens that are considered to be valid according to the schema, wherein the generating the response includes generating the response from the token in the dynamic dictionary.

Aspect 3. The method of any of Aspects 1-2, further comprising: generating a context-free grammar from the schema, wherein the context-free grammar is applied to perform the dynamically limiting the dynamic dictionary to the tokens available for output.

Aspect 4. The method of any of Aspects 1-3, further comprising: building a parser based on the context-free grammar, wherein the parser has an initial parse configuration, a function mapping a current parse configuration and next character of input to a next parse configuration, and a set of final parse configurations, and wherein any of the initial parse configuration, the current parse configuration, the next parse configuration or the set of final parse configurations comprises a stack of parser parse configurations and a lexer parse configuration.

Aspect 5. The method of any of Aspects 1-4, further comprising: generating, using the parser, an index, by: receiving a token of a string of tokens, wherein the request and the response are made up of tokens, the string of tokens including the tokens in the request and any incomplete response; and determining the set of final parse configurations for the token using the function, wherein the set of final parse configurations for the token is based on a precondition representing a predicate on the set of final parse configurations before the token can be consumed by the parser, wherein the precondition comprises a particular lexer parse configuration and a particular stack of parser parse configurations that are satisfied by the set of final parse configurations for the token.

Aspect 6. The method of any of Aspects 1-5, wherein the particular stack of parser parse configurations of the precondition comprises at least one wildcard.

Aspect 7. The method of any of Aspects 1-6, wherein the index is represented as an index trie comprising a trie path corresponding to the precondition of the string of tokens and wherein the sting of tokens are stored as a node in the index trie, the node in the index tree points to the tokens that are considered to be valid according to the schema and thereby defines the dynamic dictionary.

Aspect 8. The method of any of Aspects 1-7, further comprising: generating an optimized index from the index by: precomputing a union of token sets from nodes of the index trie satisfying a given parse configuration such that the generative response engine can extract the set of final parse configurations from a single path in the index trie.

Aspect 9. The method of any of Aspects 1-8, wherein the content is generated using the index to select valid tokens from the dynamic dictionary.

Aspect 10. The method of any of Aspects 1-9, further comprising: receiving, by the generative response engine, a string comprising a special token; based on a type of the special token, triggering constrained sampling by the generative response engine, such that output of the generative response engine is constrained to conform to the schema.

Aspect 11. A non-transitory computer-readable medium having stored thereon instructions that, when executed by at least one processor, cause the at least one processor to perform operations according to any of Aspects 1 to 10.

Aspect 12. A computing system for performing a function, comprising one or more means for performing operations according to any of Aspects 1 to 10.

The present technology includes computer-readable storage mediums for storing instructions, and systems for executing any one of the methods embodied in the instructions addressed in the aspects of the present technology presented below:

1. A method for constraining an output of a generative response engine to be a valid output for a structured format defined in a request received by the generative response engine, the method comprising:
receiving, by the generative response engine, the request to generate content that conforms to the structured format using the generative response engine, wherein the request includes a schema providing a syntax that defines valid output tokens for the structured format and wherein the generative response engine comprises a model trained to sample tokens from a probability distribution of possible tokens;
receiving, by the model, a dynamic dictionary including possible tokens from which the model can sample, wherein the possible tokens in the dynamic dictionary are constrained by the schema; and
generating, by the generative response engine, the response to the request to generate the content, wherein the response comprises tokens selected from the dynamic dictionary defining the possible tokens such that the response conforms to the structured format defined by the schema.

2. The method of claim 1, further comprising:
determining by the generative response engine that the response should conform to the structured format,
based on the determination to conform the response to the structured format, invoking a parser to assist the generative response engine in generating the response that conforms to the structured format.

3. The method of claim 1, further comprising:
dynamically limiting the dynamic dictionary of tokens available for selection by the generative response engine to tokens that are considered to be valid according to the schema, wherein the generating the response includes generating the response from the tokens in the dynamic dictionary.

4. The method of claim 3, further comprising:
building a parser based on a context-free grammar generated from the schema, wherein the parser has an initial parse configuration, a function mapping a current parse configuration and next character of input to a next parse configuration, and a set of final parse configurations, and wherein any of the initial parse configuration, the current parse configuration, the next parse configuration or the set of final parse configurations comprises a stack of parser parse configurations and a lexer parse configuration.

5. The method of claim 4, further comprising:
generating, using the parser, an index, by:
receiving a token of a string of tokens, wherein the request and the response are made up of tokens, the string of tokens including the tokens in the request and any incomplete response; and
determining the set of final parse configurations for the token using the function, wherein the set of final parse configurations for the token is based on a precondition representing a predicate on the set of final parse configurations before the token can be consumed by the parser, wherein the precondition comprises a particular lexer parse configuration and a particular stack of parser parse configurations that are satisfied by the set of final parse configurations for the token.

6. The method of claim 5, wherein the particular stack of parser parse configurations of the precondition comprises at least one wildcard.

7. The method of claim 5, wherein the index is represented as an index trie comprising a trie path corresponding to the precondition of the string of tokens and wherein the sting of tokens are stored as a node in the index trie, the node in the index tree points to the tokens that are considered to be valid according to the schema and thereby defines the dynamic dictionary.

8. The method of claim 7, further comprising:
generating an optimized index from the index by:
precomputing a union of token sets from nodes of the index trie satisfying a given parse configuration such that the generative response engine can extract the set of final parse configurations from a single path in the index trie.

9. The method of claim 5, wherein the content is generated using the index to select valid tokens from the dynamic dictionary.

10. The method of claim 1, further comprising:
receiving, by the generative response engine, a string comprising a special token;
based on a type of the special token, triggering constrained sampling by the generative response engine, such that output of the generative response engine is constrained to conform to the schema.

11. A computing system, comprising:
at least one memory; and
at least one processor coupled to the at least one memory and configured to:
receive the request to generate content that conforms to the structured format using a generative response engine, wherein the request includes a schema providing a syntax that defines valid output tokens for the structured format and wherein the generative response engine comprises a model trained to sample tokens from a probability distribution of possible tokens;
receive, by the model, a dynamic dictionary including possible tokens from which the model can sample, wherein the possible tokens in the dynamic dictionary are constrained by the schema; and
generate, by the generative response engine, the response to the request to generate the content, wherein the response comprises tokens selected from the dynamic dictionary defining the possible tokens such that the response conforms to the structured format defined by the schema.

12. The computing system of claim 11, wherein the instructions further configure the computing system to:
dynamically limit the dynamic dictionary of tokens available for selection by the generative response engine to tokens that are considered to be valid according to the schema, wherein the generating the response includes generating the response from the tokens in the dynamic dictionary.

13. The computing system of claim 12, wherein the instructions further configure the computing system to:
generate a context-free grammar from the schema, wherein the context-free grammar is applied to perform the dynamically limiting the dynamic dictionary to the tokens available for output.

14. The computing system of claim 13, wherein the instructions further configure the computing system to:
build a parser based on the context-free grammar, wherein the parser has an initial parse configuration, a function mapping a current parse configuration and next character of input to a next parse configuration, and a set of final parse configurations, and wherein any of the initial parse configuration, the current parse configuration, the next parse configuration or the set of final parse configurations comprises a stack of parser parse configurations and a lexer parse configuration.

15. The computing system of claim 14, wherein the instructions further configure the computing system to:
generate, using the parser, an index, by:
receiving a token of a string of tokens, wherein the request and the response are made up of tokens, the string of tokens including the tokens in the request and any incomplete response; and
determining the set of final parse configurations for the token using the function, wherein the set of final parse configurations for the token is based on a precondition representing a predicate on the set of final parse configurations before the token can be consumed by the parser, wherein the precondition comprises a particular lexer parse configuration and a particular stack of parser parse configurations that are satisfied by the set of final parse configurations for the token.

16. The computing system of claim 15, wherein the particular stack of parser parse configurations of the precondition comprises at least one wildcard.

17. The computing system of claim 15, wherein the index is represented as an index trie comprising a trie path corresponding to the precondition of the string of tokens and wherein the sting of tokens are stored as a node in the index trie, the node in the index tree points to the tokens that are considered to be valid according to the schema and thereby defines the dynamic dictionary.

18. The computing system of claim 17, wherein the instructions further configure the computing system to:
generate an optimized index from the index by:
precomputing a union of token sets from nodes of the index trie satisfying a given parse configuration such that the generative response engine can extract the set of final parse configurations from a single path in the index trie.

19. The computing system of claim 15, wherein the content is generated using the index to select valid tokens from the dynamic dictionary.

20. A non-transitory computer-readable storage medium comprising instructions that when executed by at least one processor, cause the at least one processor to:
receive the request to generate content that conforms to the structured format using a generative response engine, wherein the request includes a schema providing a syntax that defines valid output tokens for the structured format and wherein the generative response engine comprises a model trained to sample tokens from a probability distribution of possible tokens;
receive, by the model, a dynamic dictionary including possible tokens from which the model can sample, wherein the possible tokens in the dynamic dictionary are constrained by the schema; and
generate, by the generative response engine, the response to the request to generate the content, wherein the response comprises tokens selected from the dynamic dictionary defining the possible tokens such that the response conforms to the structured format defined by the schema.
